(19) United States
(12) Patent Application Publication
(10) Pub. No.: US 2021/0333558 A1
(43) Pub. Date: Oct. 28, 2021

(54) HEAD-MOUNTED RESILIENT AUXILIARY LOCKING MECHANISM

(71) Applicant: GOERTEK TECHNOLOGY CO.,LTD., Qingdao City (CN)

(72) Inventors: Liang WANG, Qingdao City (CN); Bin JIANG, Qingdao City (CN); Xiaoyu CHI, Qingdao City (CN)

(21) Appl. No.: 16/322,770

(22) PCT Filed: Dec. 31, 2016
(86) PCT No.: PCT/CN2016/114054

§ 371 Date: Feb. 1, 2019

(30) Foreign Application Priority Data
Aug. 2, 2016 (CN) 201610629449.3

(51) Int. Cl. G02B 27/01

(52) U.S. Cl. CPC G02B 27/0176

(57) ABSTRACT

A head-mounted resilient auxiliary locking mechanism, wherein the mechanism comprises a connecting band (3), a rear housing (1) provided at a rear of the connecting band (3), a locking module (4) provided in the rear housing (1), racks (2) provided at the two ends of the connecting band (3) and inserted into the rear housing (1) to engage with the locking module (4), and a resilient band (7) connected between the connecting band (3) and the rear housing (1); when the locking module (4) locks the racks (2), the resilient band (7) prevents the engaging between the racks (2) and the locking module (4) from loosing; and when the locking module (4) releases the racks (2), the resilient band (7) drives the racks (2) to reset. In that, the connecting band (3) is provided with the resilient band (7), to provide resilient pulling forces between the components internal of the locking mechanism, which on one hand realizes the engaged adhesion and jump preventing function, and on the other hand realizes the automatic return function.

### TECHNICAL FIELD

The present disclosure relates to a head-mounted device, and particularly relates to a head-mounted resilient auxiliary locking mechanism.

### BACKGROUND

The post-head-wearing locking mechanisms of the current head wearing virtual reality products mostly employ the binding tape type and the gear rack type. The binding tape type locking mechanisms are mainly formed by a loosen buckle and a connecting band. In operation, firstly the proper head wearing distance is regulated by using the loosen buckle, and then the product can be worn. The gear rack type locking mechanisms are mainly formed by a rack and gear assembly, and the controllable regulating of the head wearing distance is realized by the engaging and self-locking between the gear and the rack.

For example, the Chinese utility model patent “Wearing Device for Virtual Reality Headpiece” (granting publication number: CN204351143U) discloses a binding tape type locking mechanism, wherein a headpiece main body 2 is provided with a front contracting band 4a and a rear contracting band 5a, and the contracting bands have contractility, which can fit different users.

The Chinese utility model patent “Ring-Shaped Headband and Head-Worn Device Having Same” (granting publication number: CN205139466U) discloses a gear rack type locking mechanism, wherein the ring-shaped headband comprises a connecting band 1 and a regulating locking plate 2, a guiding slot opening penetrates the interior of the regulating locking plate 2, the two ends of the connecting band oppositely go through the guiding slot opening, the two ends of the connecting band are provided with sawteeth 3, the middle part of the regulating locking plate 2 is provided with a regulating knob 4 for regulating the stretching degree of the connecting band 1 by using the sawteeth 3, and the middle part of the regulating locking plate 2 is further provided with a locking element 5 for locking the regulating.

The disadvantages of the binding tape type locking mechanisms include: (1) the post-head-wearing distance is not controllable, and the degree of automation is low; (2) because of the resilience of the connecting band, they cannot bear large shaking; and (3) the connecting band has a low life, and comfortableness of the head wearing is poor.

The disadvantages of the gear rack type locking mechanisms include: (1) the head wearing distance does not have a margin for elasticity retracting, which causes poor body feeling; (2) the regulating does not have an automatic return function, which makes the regulating inconvenient; and (3) because of the back lash, the intermittent impacts between the gear and the rack result in decreased usage life.

### SUMMARY

In view of the above problems in the prior art, an object of the present disclosure is to provide a head-mounted resilient auxiliary locking mechanism, in which the connecting band is provided with a resilient band, to provide resilient pulling forces between the components internal of the locking mechanism, which on one hand realizes the engaged adhesion and jump preventing function, and on the other hand realizes the automatic return function.

In order to realize the above object, the present disclosure employs the following technical solution:

a head-mounted resilient auxiliary locking mechanism, wherein the mechanism comprises a connecting band, a rear housing provided at a rear of the connecting band, a locking module provided in the rear housing, racks provided at the two ends of the connecting band and inserted into the rear housing to engage with the locking module, and a resilient band connected between the connecting band and the rear housing; when the locking module locks the racks, the resilient band prevents the engaging between the racks and the locking module from loosing; and when the locking module releases the racks, the resilient band drives the racks to reset.

Optionally, each of the connecting band and the rear housing is fixedly attached with a buckle, and the connecting band and the rear housing are respectively fixed to one end of the resilient band by the buckle, and the resilient band is made of silica gel.

Optionally, each end of the resilient band has a claw, the buckles are provided with matching clipping holes, the ends of the resilient band protrude into the buckles and clip-connected with the buckles, and the buckles are fixed respectively on the connecting band and the rear housing by a screw.

Optionally, the locking module is provided with a bracket, the bracket is provided with a dial wheel, and is provided with a transmission gear coaxial with the dial wheel, and the racks are respectively located above and below the transmission gear and engaged with the transmission gear, the rotation of the dial wheel drives the transmission gear to rotate, and in turn drives the racks to move; and a side surface of the dial wheel is provided with a ratchet, the bracket is provided with a pawl, and the ratchet and the pawl cooperate to prevent the dial wheel from reversely rotating.

Optionally, a clutching gear is provided coaxially between the dial wheel and the transmission gear, to drive the clutching gear to axially displace to connect or disconnect transmission between the dial wheel and the transmission gear.

Optionally, a transmission shaft is provided between the dial wheel and the transmission gear, the transmission shaft is fixedly connected to the transmission gear, the transmission shaft and the clutching gear are matched by a spline, the clutching gear is reciprocatedly displaceable on the transmission shaft, and the dial wheel is provided with transmission teeth engaged with the clutching gear.

Optionally, the bracket is provided with a button, the clutching gear is pushed by using the button to displace, and the clutching gear is connected to a returning spring.

Optionally, the dial wheel merely rotates unidirectionally; when the transmission between the dial wheel and the transmission gear is connected, the transmission gear maintains equidirectional unidirectional rotation; and when the transmission between the dial wheel and the transmission gear is disconnected, the transmission gear rotates freely.

Optionally, the dial wheel merely rotates unidirectionally, and when the dial wheel rotating contracts the connecting band.

Optionally, the resilient band is made of silica gel, each end of the resilient band is provided with a connecting terminal, and the connecting terminals are provided with a plurality of fixing holes, and are fixed respectively on the connecting band and the rear housing by a screw.

The head-mounted resilient auxiliary locking mechanism employing the above structure has the following advantages:
(1) In head wearing experience it can be resiliently tensioned or strained, to increase the comfortableness.
(2) When the head wearing distance is being regulated, it can be automatically returned, which facilitates the regulating.
(3) The resilient tensioning or straining prevents intertooth jumping, which prolongs the usage life.
(4) The silica gel band has reliable properties, has low cost, is easy to handle and is replaceable.
(5) The degree of tightness can be quickly regulated in head wearing virtual reality experiencing.

### BRIEF DESCRIPTION OF DRAWINGS

FIG. 1 is a perspective view of the present disclosure;

FIG. 2 is a partial enlarged view of FIG. 1;

FIG. 3 is a perspective view of the present disclosure (wherein the buckles and the resilient band are omitted);

FIG. 4 is a perspective view of a front buckle employed in the present disclosure;

FIG. 5 is a perspective view of a rear buckle employed in the present disclosure;

FIG. 6 is a perspective view of a resilient band employed in the present disclosure;

FIG. 7 is a front view of a regulating mechanism employed in the present disclosure;

FIG. 8 is a perspective view of a regulating mechanism employed in the present disclosure;

FIG. 9 is an exploded view of a regulating mechanism employed in the present disclosure; and

FIG. 10 is a perspective view of a resilient band employed in the present disclosure.

In the drawings: 1. rear housing; 2. rack; 3. connecting band; 4. locking module; 4-1. dial wheel; 4-2. rack; 4-3. pawl; 4-4. transmission gear; 4-5. ratchet; 4-6. rack; 4-7. button; 4-8. transmission shaft; 4-9. clutching gear; 4-10. bracket; 5. front buckle; 5-1. mounting hole; 5-2. clipping hole; 5-3. receiving slot; 6. rear buckle; 6-1. mounting hole; 6-2. clipping hole; 6-3. receiving slot; 7. resilient band; 7-1. claw; and 7-2. connecting terminal.

### DETAILED DESCRIPTION

In order to make the objects, the technical solutions and the advantages of the present disclosure clearer, the present disclosure will be described below in detail in conjunction with the drawings and the particular embodiments.

### The First Embodiment

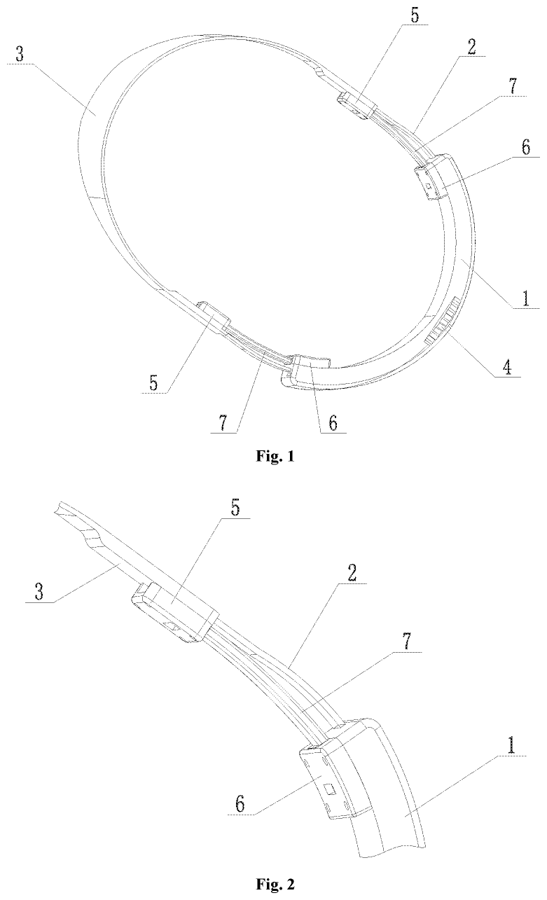

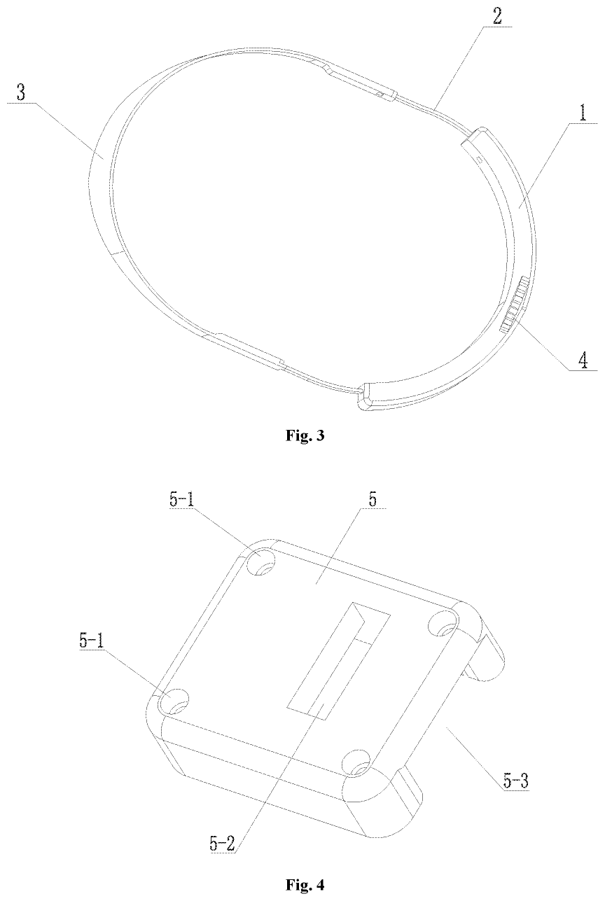

FIGS. 1, 3, 6 and 8 show one of the embodiments of the present disclosure. The present embodiment shows a head-mounted resilient auxiliary locking mechanism, wherein the mechanism comprises a connecting band 3, a rear housing 1 provided at the rear of the connecting band 3, a locking module 4 provided in the rear housing 1, racks 2 provided at the two ends of the connecting band 3 and inserted into the rear housing 1 to engage with the locking module 4, and a resilient band 7 is connected between the connecting band 3 and the rear housing 1; when the locking module 4 locks the racks 2, the resilient band 7 prevents the engaging between the rack 4-2 and the locking module 4 from loosing; and when the locking module 4 releases the racks 2, the resilient band 7 drives the racks 2 to reset.

The resetting here refers to that the resilient band 7 drives the racks 2 to move until the resilient band 7 is in an un-stressed state, in which it is not tensioned and is not compressed, which may be considered as the starting point of the regulating. When the head-mounted resilient auxiliary locking mechanism is used, it is required to be regulated to fit the size of the head, and after the regulating the resilient band 7 is usually tensioned or compressed. When the resilient band 7 is being tensioned or compressed, the locking module 4 and the racks 2 are engaged and adhered together, which prevents jumping.

In the present embodiment the connecting band 3 itself does not have retractility, is made of a material that does not have retractility, for example plastic, and is formed integrally with the racks 2.

As shown in FIGS. 1 and 2, each of the connecting band 3 and the rear housing 1 is fixedly attached with a buckle, i.e., the front buckle 5 and the rear buckle 6 in the drawings, and the connecting band and the rear housing are respectively fixed to one end of the resilient band 7 by the buckle. The resilient band 7 is made of silica gel. The resilient band 7 may also employ other materials that have elasticity, such as rubber.

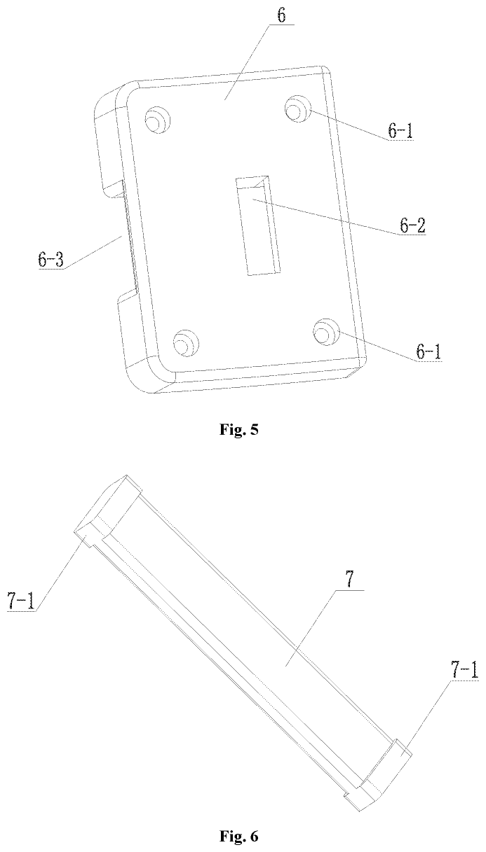

As shown in FIGS. 4, 5 and 6, each end of the resilient band 7 has a claw 7-1, the front buckle 5 is provided with a matching clipping hole 5-2, the rear buckle 6 is provided with a matching clipping hole 6-2, the ends of the resilient band 7 protrude into the buckles and clip-connected with the buckles, and the buckles are fixed respectively on the connecting band 3 and the rear housing 1 by a screw.

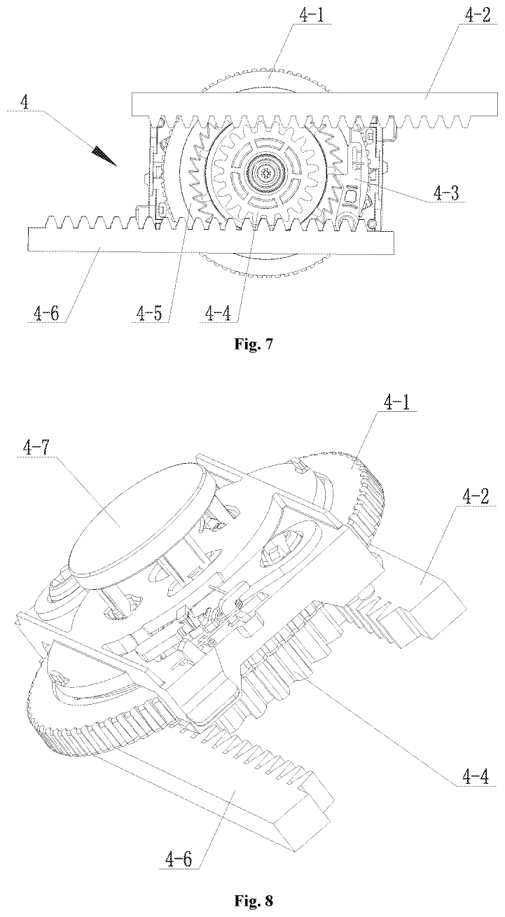

As shown in FIGS. 7, 8 and 9, the locking module 4 is provided with a bracket 4-10, the bracket 4-10 is provided with a dial wheel 4-1, and is provided with a transmission gear 4-4 coaxial with the dial wheel 4-1, and the racks 2 are respectively located above and below the transmission gear 4-4 and engaged with the transmission gear 4-4, the rotation of the dial wheel 4-1 drives the transmission gear 4-4 to rotate, and in turn drives the racks 2 to move; and a side surface of the dial wheel 4-1 is provided with a ratchet 4-5, the bracket 4-10 is provided with a pawl 4-3, and the ratchet 4-5 and the pawl 4-3 cooperate to prevent the dial wheel 4-1 from reversely rotating.

The locking module 4 is mounted in the rear housing 1, and merely the dial wheel 4-1 is partially exposed, as shown in FIG. 1.

A clutching gear 4-9 is provided coaxially between the dial wheel 4-1 and the transmission gear 4-4, to drive the clutching gear 4-9 to axially displace, to connect or disconnect the transmission between the dial wheel 4-1 and the transmission gear 4-4.

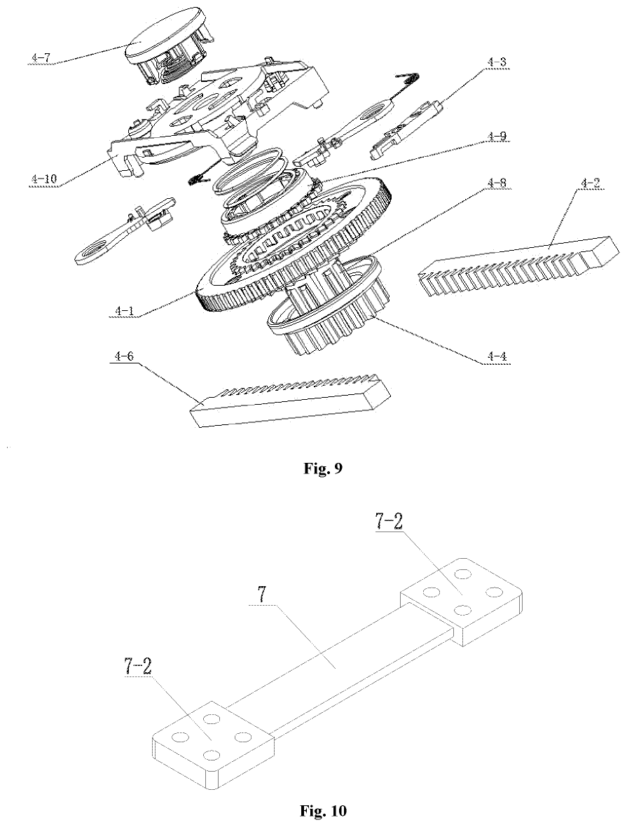

As shown in FIG. 9, a transmission shaft 4-8 is provided between the dial wheel 4-1 and the transmission gear 4-4, the transmission shaft 4-8 is fixedly connected to the transmission gear 4-4, the transmission shaft 4-8 and the clutching gear 4-9 are matched by a spline, the clutching gear 4-9 is reciprocatedly displaceable on the transmission shaft 4-8, and the dial wheel 4-1 is provided with transmission teeth engaged with the clutching gear 4-9.

The bracket 4-10 is provided with a button 4-7, the clutching gear 4-9 is pushed by using the button 4-7 to displace, and the clutching gear 4-9 is connected to a returning spring. The button 4-7 may also be provided with a returning spring.

The dial wheel 4-1 merely rotates unidirectionally; when the transmission between the dial wheel 4-1 and the transmission gear 4-4 is connected, the transmission gear 4-4 maintains equidirectional unidirectional rotation; and when the transmission between the dial wheel 4-1 and the transmission gear 4-4 is disconnected, the transmission gear 4-4 rotates freely.

In the present embodiment, the dial wheel 4-1 when rotating unidirectionally contracts the connecting band 3.

### The Second Embodiment

In the present embodiment, as shown in FIG. 10, the resilient band 7 is made of silica gel, each end of the resilient band 7 is provided with a connecting terminal 7-2, and the connecting terminal 7-2 is provided with a plurality of fixing holes and are fixed respectively on the connecting band 3 and the rear housing 1 by a screw. In order to ensure the connection strength, the connecting terminal 7-2 preferably has increased thickness and width.

Such a design can eliminate the buckles, and simplifies the mounting structure of the resilient band 7.

The above are only embodiments of the present disclosure, and are not limiting the protection scope of the present disclosure. Any modifications, equivalent substitutions, improvements or expanding that are made within the spirit and principle of the present disclosure are all included in the protection scope of the present disclosure.

1-20. (canceled)

21. A head-mounted resilient auxiliary locking mechanism, wherein the mechanism comprises a connecting band, a rear housing provided at a rear of the connecting band, a locking module provided in the rear housing, racks provided at the two ends of the connecting band and inserted into the rear housing to engage with the locking module, and a resilient band connected between the connecting band and the rear housing; when the locking module locks the racks, the resilient band prevents the engaging between the racks and the locking module from loosing; and when the locking module releases the racks, the resilient band drives the racks to reset.

22. The head-mounted resilient auxiliary locking mechanism according to claim 1, wherein each of the connecting band and the rear housing is fixedly attached with a buckle, and the connecting band and the rear housing are respectively fixed to one end of the resilient band by the buckle, and the resilient band is made of silica gel.

23. The head-mounted resilient auxiliary locking mechanism according to claim 2, wherein each end of the resilient band has a claw, the buckles are provided with matching clipping holes, the ends of the resilient band protrude into the buckles and clip-connected with the buckles, and the buckles are fixed respectively on the connecting band and the rear housing by a screw.

24. The head-mounted resilient auxiliary locking mechanism according to claim 1, wherein the locking module is provided with a bracket, the bracket is provided with a dial wheel, and is provided with a transmission gear coaxial with the dial wheel, and the racks are respectively located above and below the transmission gear and engaged with the transmission gear, the rotation of the dial wheel drives the transmission gear to rotate, and in turn drives the racks to move; and a side surface of the dial wheel is provided with a ratchet, the bracket is provided with a pawl, and the ratchet and the pawl cooperate to prevent the dial wheel from reversely rotating.

25. The head-mounted resilient auxiliary locking mechanism according to claim 4, wherein a clutching gear is provided coaxially between the dial wheel and the transmission gear, to drive the clutching gear to axially displace to connect or disconnect transmission between the dial wheel and the transmission gear.

26. The head-mounted resilient auxiliary locking mechanism according to claim 5, wherein a transmission shaft is provided between the dial wheel and the transmission gear, the transmission shaft is fixedly connected to the transmission gear, the transmission shaft and the clutching gear are matched by a spline, the clutching gear is reciprocatedly displaceable on the transmission shaft, and the dial wheel is provided with transmission teeth engaged with the clutching gear.

27. The head-mounted resilient auxiliary locking mechanism according to claim 5, wherein the bracket is provided with a button, the clutching gear is pushed by using the button to displace, and the clutching gear is connected to a returning spring.

28. The head-mounted resilient auxiliary locking mechanism according to claim 5, wherein the dial wheel merely rotates unidirectionally; when the transmission between the dial wheel and the transmission gear is connected, the transmission gear maintains equidirectional unidirectional rotation; and when the transmission between the dial wheel and the transmission gear is disconnected, the transmission gear rotates freely.

29. The head-mounted resilient auxiliary locking mechanism according to claim 4, wherein the dial wheel merely rotates unidirectionally, and when the dial wheel rotating contracts the connecting band.

30. The head-mounted resilient auxiliary locking mechanism according to claim 1, wherein the resilient band is made of silica gel, each end of the resilient band is provided with a connecting terminal, and the connecting terminals are provided with a plurality of fixing holes, and are fixed respectively on the connecting band and the rear housing by a screw.
